(19) United States
(12) Patent Application Publication
(10) Pub. No.: US 2010/0131942 A1
(43) Pub. Date: May 27, 2010

(54) SUITE-BASED INTEGRATION AND DEPLOYMENT OF BUSINESS PRODUCTS

(75) Inventors: John R. Nannenga, Fargo, ND (US); Michael S. Hammond, Moorhead, MN (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/276,298

(22) Filed: Nov. 21, 2008

(51) Int. Cl. G06F 9/445

(52) U.S. Cl. 717/176

(57) ABSTRACT

Architecture having a single (or workbench) application via which a user can select and integrate products for deployment to machines. The user can interact with the workbench application to define an ERP (enterprise resource planning) system, for example. Products are added to the workbench where the user has the option to configure product settings. Product dependencies are automatically resolved such that settings previously input and that apply as passed to subsequent products. The user then maps these product settings into roles which are assigned to individual machines. The workbench then determines and ultimately queues up the actual deployment tasks which need to occur on individual machines to configure each machine to match its associated role(s). The user can then select which tasks (or all) to execute at which point the workbench invokes remote configuration of said machines. Live progress and logging information is returned through the workbench.

### BACKGROUND

Enterprise resource planning (ERP) systems are complex and oftentimes require a number of interdependent, integrating pieces. In one example, a development system ships the core product and includes additional features of the ERP system as integrating products. The deployment of those integrating products not only depends upon information entered during the initial deployment of development, but can also depend upon settings of other, required integrating products which might not be available until after that product is deployed. This scenario is further complicated where the development system includes a partner channel which delivers enhancements, vertical SKUs (stock keeping units), etc., through integrating product installations.

Users wishing to deploy such ERP systems often end up perusing through product documentation to discover operating system requirements, product interdependencies, command line deployment options, supported software configurations, and other information. Armed with this information, the user can then begin to piece together where products can be installed, how the products should be installed (e.g., configuration options), the order of product install, the additional configuration steps employed to complete the deployment of a product before the next product can be installed, and so on. The user then physically sets up each destination machine, whether a client or a server. Only after all this initial tedious effort, the user may then begin thinking about how to automate pieces of the deployment components using familiar technologies such as group policy deployment, systems management, various scripting languages, and so on.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture employs a “suite” concept for deploying a solution (e.g., ERP-enterprise resource planning) by providing a consistent user interface where components can have some level of interaction. In the context of an ERP deployment, the individual pieces comprising the ERP system can be amalgamated into a synergistic whole that allows customers to focus on deployment rather than all of the individual pieces of the system. Moreover, this further facilitates remote installation by the user.

The architecture provides a single (or workbench) application via which a user can select and integrate products for deployment to destination machines. For example, the user can interact with the workbench application to define the ERP system. Products are added to the workbench whereby the user can then define settings for each of the products. Product dependencies are automatically resolved such that settings previously input and that apply are passed to subsequent product settings. In other words, only relevant settings are passed forward. The product settings are then mapped into roles (e.g., client, server, etc.) and assigned to individual destination machines. The workbench determines and ultimately queues up the actual deployment tasks which need to occur on the individual machines for the designated role. Live progress and logging information is returned through the workbench.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented application integration and deployment system in accordance with the disclosed architecture.

FIG. 2 illustrates a more detailed system that employs a workbench application for application integration and deployment.

FIG. 3 illustrates a more detailed embodiment as to how the setting component creates and propagates product settings to subsequent product setup and configuration.

FIG. 4 illustrates dependency resolution by the dependency component for relevant settings generation by the settings component.

FIG. 5 illustrates a system for mapping product settings to roles and machine designations.

FIG. 6 illustrates a subsystem for task execution for deployment of roles to destination machines.

FIG. 7 illustrates an alternative representation of a process for product integration and deployment.

FIG. 8 illustrates a method of deploying an application.

FIG. 9 illustrates a method of obtaining settings for product integration.

FIG. 10 illustrates a method of deploying products and product settings based on roles.

FIG. 11 illustrates a block diagram of a computing system operable to execute product integration and deployment as a suite in accordance with the disclosed architecture.

FIG. 12 illustrates a schematic block diagram of a computing environment for product integration and deployment as a suite.

### DETAILED DESCRIPTION

The disclosed architecture provides a single (or workbench) application via which a user can select and integrate products for deployment to machines. For example, the user can interact with the workbench application to define an ERP (enterprise resource planning) system. Products are added to the workbench where the user then has the option to configure product settings. Product dependencies are automatically resolved such that settings previously input and that apply are passed to subsequent products. In other words, only relevant settings are passed forward to new products being integrated. The user then maps these product settings into roles which then in turn are assigned to individual machines. The workbench then determines and ultimately queues up the actual deployment tasks which need to occur on individual machines to configure each machine to match its associated role(s). The user can then select which tasks (or all) to execute at which point the workbench invokes remote configuration of said machines. Live progress and logging information is returned through the workbench.

The workbench application facilitates a mass deployment option that is simple, can use command line customization, provides application upgrade, information logging, support localized installs and the “suite” concept, has simple licensing, provides a user interface (UI) to capture settings, support push deployment and maintenance (e.g., patching, removing, updating, repairing, etc.) of installed applications, third-party product integration, bootstrap installation, and push deployment to a single machine to types of machine roles, for example. The disclosed workbench application also finds applicability to database maintenance, installation and configuration, for example.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

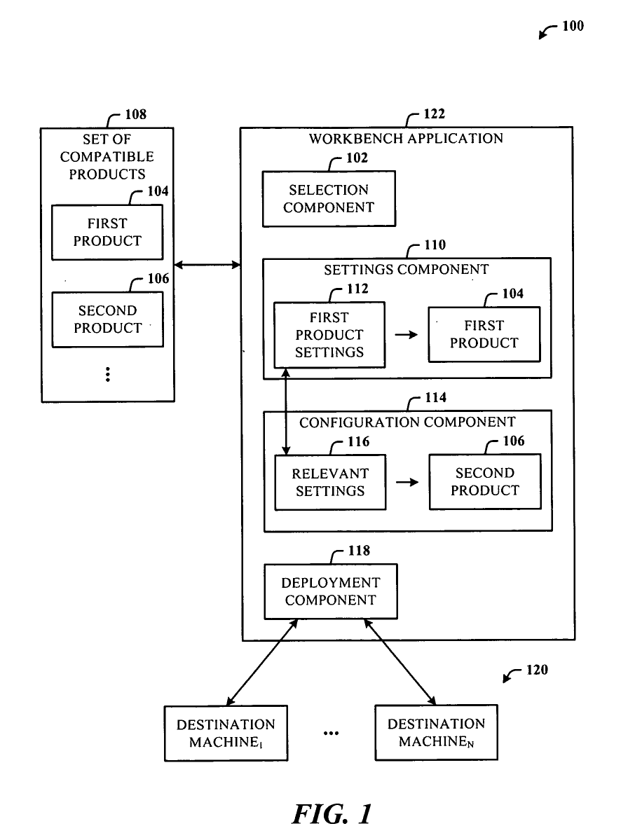

FIG. 1 illustrates a computer-implemented application integration and deployment system 100 in accordance with the disclosed architecture. The system 100 includes a selection component 102 for selecting a first product 104 and a second product 106 from a set 108 of compatible products for integration. A settings component 110 is provided for applying first product settings 112 to the first product 104.

The system 100 can further include a configuration component 114 for automatically configuring the second product 106 according to relevant settings 116 that are relevant to the second product 106. The relevant settings 116 are obtained from the first product settings 112. A deployment component 118 is employed for installing the first product 104 and the second product 106 as a product suite on destination machines 120 (denoted Destination Machine₁, . . . ,Destination Machine_{N}).

The configuration component 114 requests additional settings not included in the relevant settings 116 for configuration of the second product 106. This can be accomplished by prompting the user for the additional settings that cannot be obtained from the relevant settings 116. These additional settings can be mappings to data (e.g., financial, human resources, sales, etc.) that are not already provided in the relevant settings 116, or links to user interface (UI) templates for creating the UI, custom settings only for that particular product, and so on. In one embodiment, the set 108 of compatible products can be related to enterprise resource planning (ERP) products, for example.

The system 100 can be provided as a single application (workbench application 122) via which all dependencies are identified and resolved, product settings (relevant and non-relevant) are determined and applied such that the products can be integrated and deployed according to a “suite” concept.

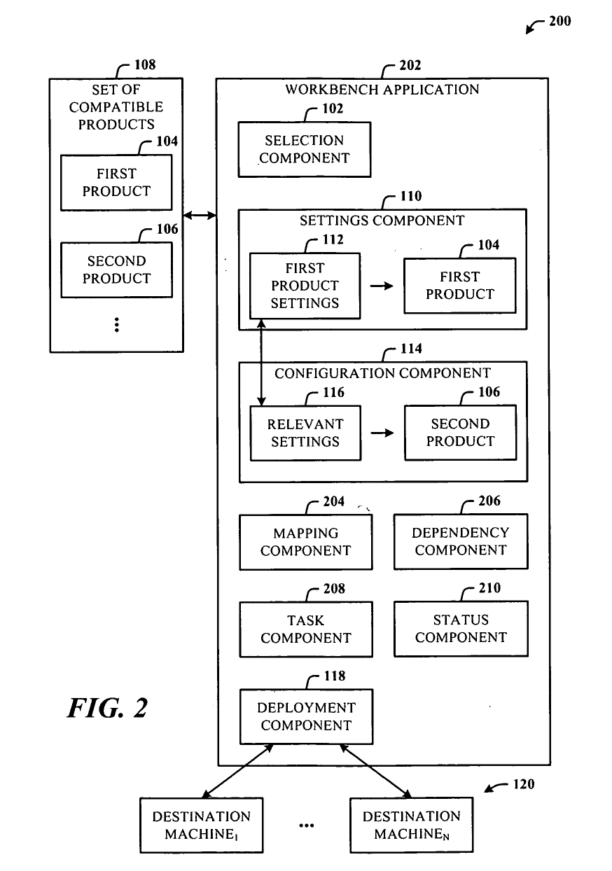

FIG. 2 illustrates a more detailed system 200 that employs a workbench application 202 for application integration and deployment. Here, the workbench application 200 further includes a mapping component 204 for mapping the configured first product settings 112 and second product settings into roles for deployment to the destination machines 120 according to machine roles. The 200 also depicts the workbench application 202 as including a dependency component 206 for identifying and resolving the dependencies between the first product 104 and the second product 106. A task component 208 enqueues tasks to be executed on the destination machines 120. The tasks define roles for each of the destination machines 120 as a client or a server, for example. Other types of roles may also be employed. The deployment component 118 facilitates selection of some or all of the tasks, the selection of which initiates remote installation of the product suite on one or more of the destination machines 120 according to an assigned role. The workbench application 202 can further include a status component for providing installation progress information and logging information as to the status (e.g., success, failure, errors, etc.) of the installation.

As illustrated, the system 200 includes the selection component 102 for selecting the first product 104 and the second product 106 from the set 108 of compatible products for integration. The settings component 110 applies the first product settings 112 to the first product 104, and the configuration component 114 automatically configures the second product 106 according to relevant settings 116 that are relevant to the second product 106. The deployment component 118 installs the first product 104 and the second product 106 as a product suite on the destination machines 120.

Put another way, the computer-implemented application integration and deployment system 200 includes the selection component 102 for selecting the first product 104 and the second product 106 from the set 108 of compatible products for integration, the settings component 110 for applying the first product settings 112 to the first product 104, and the configuration component 114 for automatically configuring the second product 106 according to relevant settings 116 that are relevant to the second product 106, the relevant settings 116 are obtained from the first product settings 112. The dependencies component 206 identifies and resolves dependencies between the first product 104 and the second product 106. The mapping component 204 maps the configured first product settings 112 and second product settings into roles for deployment to the destination machines 120 according to machine roles. The deployment component 118 installs the first product 104 and the second product 106 as a product suite on some or all of the destination machines 120. The status component 210 receives and provides installation progress information and logging information.

The configuration component 114 requests additional settings not included in the relevant settings 116 for configuration of the second product. Thus, the user may be requested to input these additional settings. The task component 208 queues tasks to be executed on the destination machines 120, where the tasks define a role of a destination machine as a client or a server, and the deployment component 118 facilitates selection of some or all of the tasks, the selection of which initiates remote and orderly installation of the product suite on one or more of the destination machines 120 according to an assigned role.

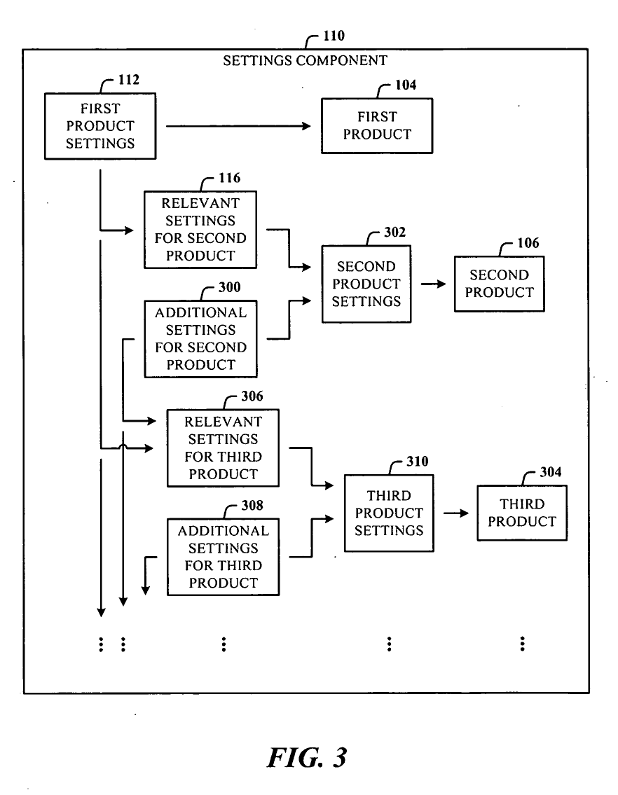

FIG. 3 illustrates a more detailed embodiment as to how the setting component 110 creates and propagates product settings to subsequent product setup and configuration. Here, the first product settings 112 are input and applied to the first product 104. Input can be manual and/or automatic. In other words, the setting component 110 can automatically search for data sources, other programs, modules, code, scripts, etc., that can be used to configure the first product 104 as desired. Thereafter, the settings and configuration process for the remaining products becomes easier, since most settings are created for the first product 104.

For example, when the second product 106 is to be configured, the relevant settings 116 for the second product are obtained from the first product settings 112. The relevant settings 116 can include some or all of the first product settings 112. Since the second product 106 is likely to be different from the first product 104, additional settings 300 for the second product can be obtained by user input and/or automatic search and insert by settings component 110 for perusal and selection by the user. The relevant settings 116 and additional settings 300 for the second product can then be combined as the second product settings 302 for the second product 106.

Continuing with integration of a third product 304, when the third product 304 is to be configured, relevant settings 306 for the third product can be obtained from the first product settings 112 and now, the additional settings 300 for the second product. The relevant settings 306 for the third product can include some or all of the first product settings 112 and some or all of the additional settings 300 for the second product. Since the third product 304 is likely to be different from the first product 104, additional settings 308 for the third product can be obtained by user input and/or automatic search and insert by the settings component 110 for perusal and selection by the user. The relevant settings 306 and additional settings 308 for the third product can then be combined as the third product settings 310 for the third product 304.

This process can continue for additional product integration by leveraging prior knowledge at least in terms of settings provided by previous products. In other words, the relevant settings for a forth product can be obtained from the first product settings 112, the additional settings 300 for the second product, and the additional settings 308 of the third product.

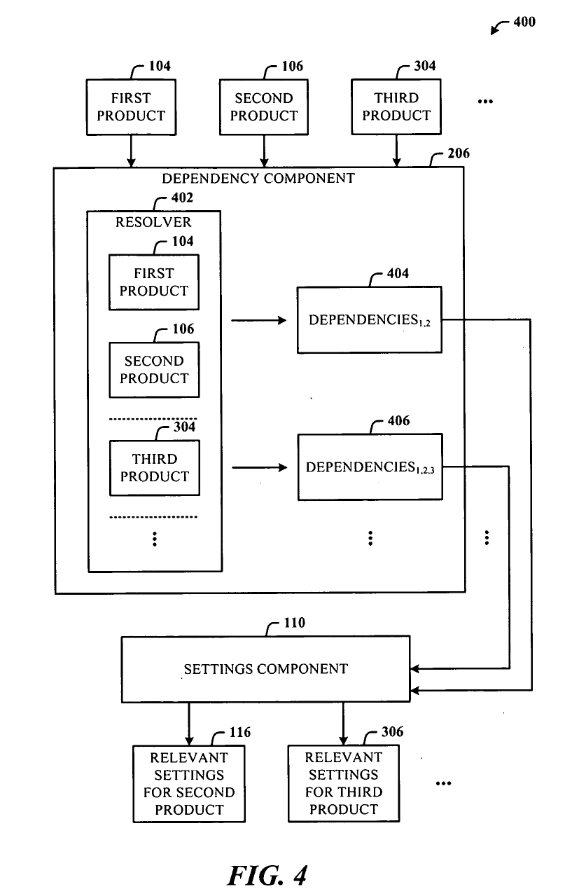

FIG. 4 illustrates a system 400 for dependency resolution by the dependency component 206 for relevant settings generation by the settings component 110. The dependency component 206 can process the products as an accumulation as more products are integrated using the workbench application. In other words, the dependency component 206 can further include a resolver 402 that resolves dependencies between a product being added and the previously integrated products. For example, the resolver 402 processes the first product 104 and second product 106 to derive dependencies 404 (denoted Dependencies_{1,2}) that are then passed to the settings component 110 to determine the relevant settings 116 for the second product.

Similarly, the resolver 402 processes the first product 104, second product 106, and third product 304 to derive dependencies 404 (denoted Dependencies_{1,2,3}) for all three products, that are then passed to the settings component 110 to determine the relevant settings 306 for the third product. Note that the dependencies 406 can include processing related to the first product 104 and second product 106, the first product 104 and the third product 304, and the second product 106 and the third product 304, or any subset thereof. This process then continues for each subsequent product, thereby making the settings and configuration easier as the more products are added. It is to be understood, however, that it is possible that a new product being integrated may still require an equal or greater amount of settings work than a previous product install.

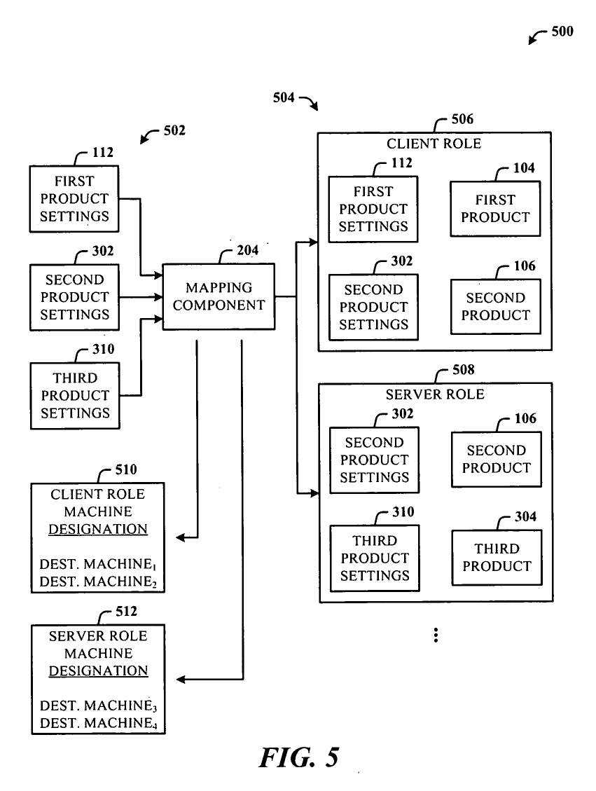

FIG. 5 illustrates a system 500 for mapping product settings 502 to roles 504 and machine designations. The mapping component 204 receives product settings 502 and then maps the product settings 502 to the roles 504. The roles 504 can include a client role 506 and a server role 508, for example. Here, the product settings 502 include the first product settings 12, the second product settings 302, and the third product settings 310 are mapped into the roles 504. The first product 104 and first product settings 112, the second product 106 and second product settings 302 are mapping into the client role 506. The second product 106, second product settings 302, third product 304, and third product settings 310 are mapped into the server role 508.

The mapping component 204 can also assign the roles 504 to destination machines using machine designations. Here, a client role machine designation 510 includes assignments of the client role 506 to a first destination machine (denoted Dest. Machine₁) and a second destination machine (denoted Dest. Machine₂). A server role machine designation 512 includes assignments of the server role 508 to a third destination machine (denoted Dest. Machine₃) and a fourth destination machine (denoted Dest. Machine₄). The deployment and installation of the roles 504 will now be described.

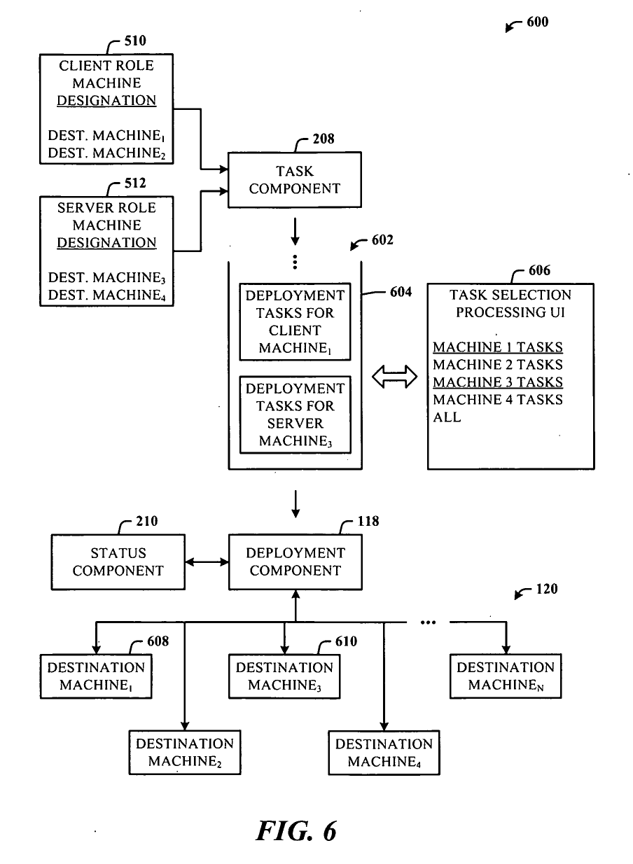

FIG. 6 illustrates a subsystem 600 for task execution for deployment of roles to destination machines 120. The client machine role designation 510 and server role machine designation 512 are input to the task component 208, which generated and queues tasks 602 in a queue 604. A task selection UI 606 allows the user to select some or all of the tasks for machine deployment. Here, the user has selected deployment tasks for product deployment on a first destination machine 608 and a third destination machine 610. Once deployed, the tasks 602 will execute on the destination machines resulting in the first destination machine 608 becoming a client and the third destination machine 610 becoming server. Install status information and logging information is returned by the first destination machine 608 and the third destination machine 610 during the remote install process. This information can be passed through the deployment component 118 to the status component 210 or directly to the status component 210. As indicated, the user can select to push the deployment tasks 602 to all machines designated to be clients, all machines designated to be servers, individually to each client or server, or all machines concurrently.

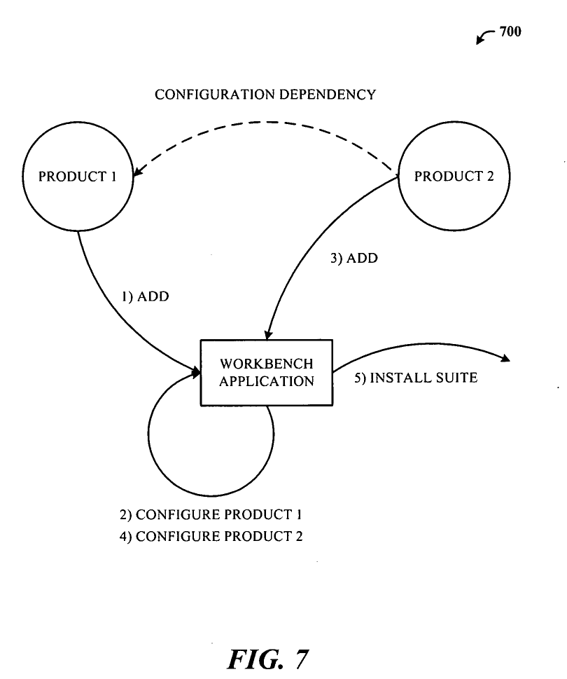

FIG. 7 illustrates an alternative representation of a process 700 for product integration and deployment. At 1), the user first adds Product 1 to the workbench application (e.g., workbench application 122 or workbench application 202). At 2), the user is then prompted to provide the configuration settings for Product 1. At 3), the user adds Product 2 to the workbench application. At 4), the user is then prompted to provide the configuration settings for Product 2. Since the dependency(ies) between Product 1 and Product 2 are known by the workbench application, the related configuration settings for Product 2 are automatically provided; that is, the user is not prompted for that information. At 5), the user chooses to deploy the suite of products defined within the workbench application. Product dependencies are resolved and the workbench application deploys Product 1 before Product 2.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

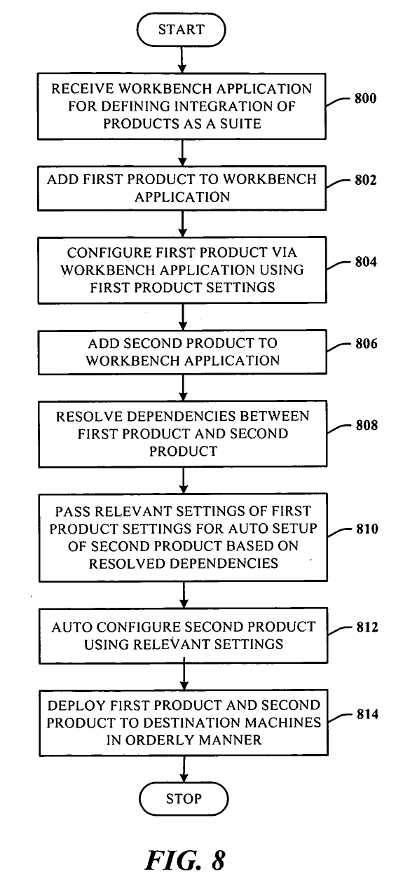

FIG. 8 illustrates a method of deploying an application. At 800, a workbench application is received for defining integration of products as a suite. At 802, a first product is added to the workbench application. At 804, the first product is configured via the workbench application using first product settings. At 806, a second product is added to the workbench application. At 808, dependencies between the first product and the second product are resolved. At 810, relevant settings of the first product settings are passed to the second product for automatic setup of the second product based on the resolved dependencies. At 812, the second product is automatically configured using the relevant settings. At 814, the first product and the second product are deployed to destination machines in an orderly manner (or install).

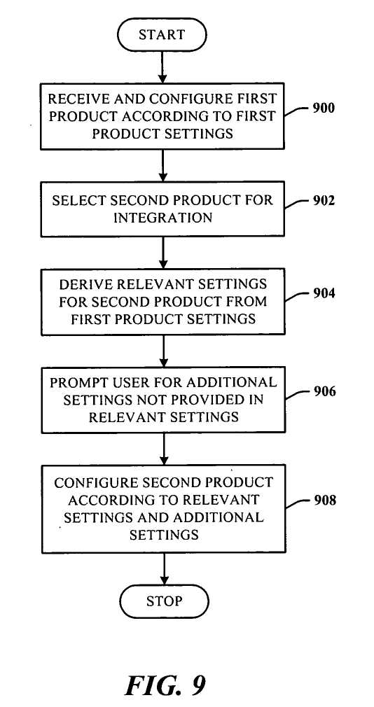

FIG. 9 illustrates a method of obtaining settings for product integration. At 900, a first product is received and configured according to first product settings. At 902, a second product is selected for integration. At 904, relevant settings for second product are derived from first product settings. At 906, a user is prompted for additional settings not provided in relevant settings. At 908, the second product according is configured to relevant settings and additional settings.

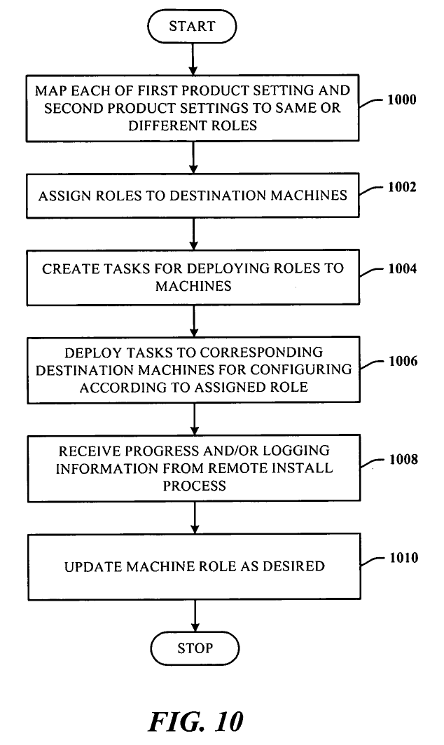

FIG. 10 illustrates a method of deploying products and product settings based on roles. At 1000, each of first product settings and second product settings are mapped the same or different roles. In other words, the first product settings can be mapped to a client role and the second product settings can be mapped to a server role or a client role. At 1002, the roles can be assigned to destination machines. At 1004, tasks are created for deploying the roles to the destination machines. The tasks can be enqueued in the workbench application for user-initiated selection and deployment to the designated destination machine(s) for automatic configuration of the destination machines. At 1006, the tasks are deployed to the destination machines for configuring the destination machines to the assigned role.

At 1008, progress information and/or logging information can be received back from the destination machine related to remote installation of a product. At 1010, a role for a machine can be updated as desired.

A role is defined by a user of the workbench application and updated due to action of the user within the workbench application. A role knows of machine assignments and product configurations.

Consider the following example. A user of the workbench application adds (and subsequently configures) ‘Product One’ and ‘Product Two’ to the workbench. The user then creates ‘Role X’ and places a configuration of ‘Product One’ into that role. The user then assigns ‘Machine 1’ to ‘Role X’. As ‘Role X’ is created and subsequently modified (e.g., addition of ‘Product One’, addition of ‘Machine 1’), background tasks within the workbench application query the environment and generate tasks which (when executed) bring the environment up to date. Thus, a deployment task is generated that when invoked adds the configuration of ‘Product One’ to ‘Machine 1’ (assuming that configuration does not already exist on ‘Machine 1’).

The success/failure of task execution is returned to the user through the workbench application. When the user starts the workbench application or chooses to ‘re-query/update’ the status information, background tasks run through the defined roles gathering product configuration information and machine assignment information, and then query the respective machine(s) to ensure the machine matches what is defined in the associated role(s). Any deviations cause deployment tasks to be generated to bring such machines in-line with the current definition of the role.

Extending the example, consider that a user of ‘Machine 1’ removes the configuration of ‘Product One’ from the machine. The next time the workbench application is launched or a user already within the workbench application chooses to update status information (or status information was “silently” retrieved within the running workbench application, e.g., similar to e-mails arriving in an inbox), a task can be generated to add the configuration of ‘Product One’ to ‘Machine 1’.

In other words, the role is defined at the workbench application, after which tasks are selected and sent to the destination to update the machine as to the updated role. Other destination machines operating in the same role are updated in a similar fashion. The machine role can be changed entirely to a different role in the same way, by changing the machine role at the workbench application to the new role, and then sending a new set of tasks to the machine to operate the machine according to the new role. Moreover, it is possible for a machine to be a member of multiple roles simultaneously.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

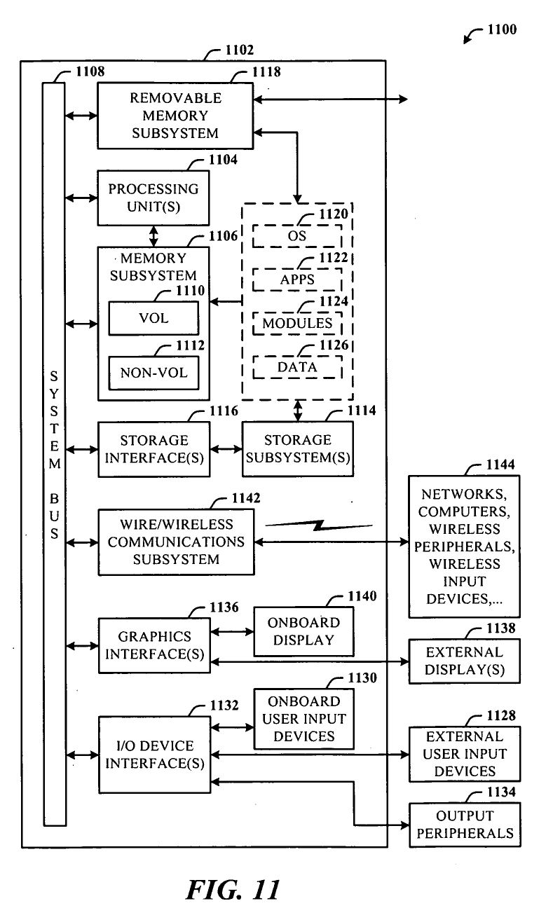

Referring now to FIG. 11, there is illustrated a block diagram of a computing system 1100 operable to execute product integration and deployment as a suite in accordance with the disclosed architecture. In order to provide additional context for various aspects thereof, FIG. 11 and the following discussion are intended to provide a brief, general description of the suitable computing system 1100 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1100 for implementing various aspects includes the computer 1102 having processing unit(s) 1104, a system memory 1106, and a system bus 1108. The processing unit(s) 1104 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1106 can include volatile (VOL) memory 1110 (e.g., random access memory (RAM)) and non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the memory subsystem 1106 to the processing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes storage subsystem(s) 1114 and storage interface(s) 1116 for interfacing the storage subsystem(s) 1114 to the system bus 1108 and other desired computer components. The storage subsystem(s) 1114 can include one or more of a hard disk drive (HDD), a magnetic floppy disk drive (FDD), and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a removable memory subsystem 1118 (e.g., flash drive form factor technology), and/or the storage subsystem(s) 1114, including an operating system 1120, one or more application programs 1122, other program modules 1124, and program data 1126. The one or more application programs 1122, other program modules 1124, and program data 1126 can include the workbench application 122, set of compatible products 108, the workbench application 202, the settings component 110 and sub-entities of FIG. 3, the system 400 of FIG. 4, the system 500 of FIG. 5, the subsystem 600 (other than the destination machines 120), the process 700 of FIG. 7, and the method of FIGS. 8-10, for example.

Generally, programs include routines, methods, data structures, other software components, etc., that perform particular tasks or implement particular abstract data types. All or portions of the operating system 1120, applications 1122, modules 1124, and/or data 1126 can also be cached in memory such as the volatile memory 1110, for example. It is to be appreciated that the disclosed architecture can be implemented with various commercially available operating systems or combinations of operating systems (e.g., as virtual machines).

The storage subsystem(s) 1114 and memory subsystems (1106 and 1118) serve as computer readable media for volatile and non-volatile storage of data, data structures, computer-executable instructions, and so forth. Computer readable media can be any available media that can be accessed by the computer 1102 and includes volatile and non-volatile media, removable and non-removable media. For the computer 1102, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1102, programs, and data using external user input devices 1128 such as a keyboard and a mouse. Other external user input devices 1128 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1102, programs, and data using onboard user input devices 1130 such a touchpad, microphone, keyboard, etc., where the computer 1102 is a portable computer, for example. These and other input devices are connected to the processing unit(s) 1104 through input/output (I/O) device interface(s) 1132 via the system bus 1108, but can be connected by other interfaces such as a parallel port, IEEE 1394 serial port, a game port, a USB port, an IR interface, etc. The I/O device interface(s) 1132 also facilitate the use of output peripherals 1134 such as printers, audio devices, camera devices, and so on, such as a sound card and/or onboard audio processing capability.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP) using logical connections via a wire/wireless communications subsystem 1142 to one or more networks and/or other computers. The other computers can include workstations, servers, routers, personal computers, microprocessor-based entertainment appliance, a peer device or other common network node, and typically include many or all of the elements described relative to the computer 1102. The logical connections can include wire/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wire/wireless communication subsystem 1142 (e.g., a network interface adapter, onboard transceiver subsystem, etc.) to communicate with wire/wireless networks, wire/wireless printers, wire/wireless input devices 1144, and so on. The computer 1102 can include a modem or has other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wire/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

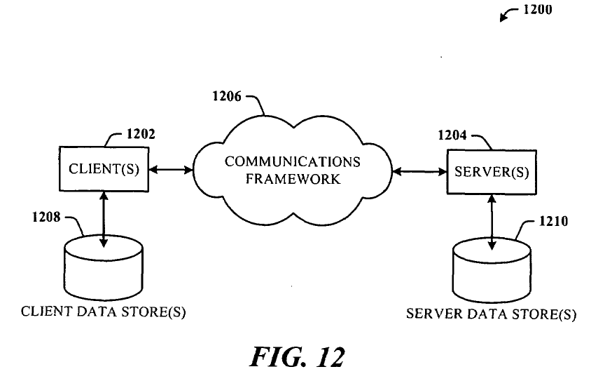

Referring now to FIG. 12, there is illustrated a schematic block diagram of a computing environment 1200 for product integration and deployment as a suite. The environment 1200 includes one or more client(s) 1202. The client(s) 1202 can be hardware and/or software (e.g., threads, processes, computing devices). The client(s) 1202 can house cookie(s) and/or associated contextual information, for example.

The environment 1200 also includes one or more server(s) 1204. The server(s) 1204 can also be hardware and/or software (e.g., threads, processes, computing devices). The servers 1204 can house threads to perform transformations by employing the architecture, for example. One possible communication between a client 1202 and a server 1204 can be in the form of a data packet adapted to be transmitted between two or more computer processes. The data packet may include a cookie and/or associated contextual information, for example. The environment 1200 includes a communication framework 1206 (e.g., a global communication network such as the Internet) that can be employed to facilitate communications between the client(s) 1202 and the server(s) 1204.

Communications can be facilitated via a wire (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

The client(s) 1202 can be those machines assigned the client role as defined and installed, and the server(s) 1204 can be those machines assigned the server role as defined and installed.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented application integration and deployment system, comprising:
a selection component for selecting a first product and a second product from a set of compatible products for integration;
a settings component for applying first product settings to the first product;
a configuration component for automatically configuring the second product according to relevant settings that are relevant to the second product, the relevant settings obtained from the first product settings; and
a deployment component for installing the first product and the second product as a product suite on destination machines.

2. The system of claim 1, wherein the configuration component requests additional settings not included in the relevant settings for configuration of the second product.

3. The system of claim 1, further comprising a mapping component for mapping the configured first product settings and second product settings into roles for deployment to the destination machines according to machine roles.

4. The system of claim 1, further comprising a task component for queuing tasks to be executed on the destination machines, the tasks defining a role of a destination machine as a client or a server.

5. The system of claim 4, wherein the deployment component facilitates selection of some or all of the tasks, the selection of which initiates remote installation of the product suite on one or more of the destination machines according to an assigned role.

6. The system of claim 1, further comprising a status component for providing installation progress information and logging information.

7. The system of claim 1, wherein the set of compatible products are related to enterprise resource planning (ERP) products.

8. The system of claim 1, further comprising a dependency component for identifying and resolving dependencies between the first product and the second product.

9. A computer-implemented application integration and deployment system, comprising:
a selection component for selecting a first product and a second product from a set of compatible products for integration;
a settings component for applying first product settings to the first product;
a configuration component for automatically configuring the second product according to relevant settings that are relevant to the second product, the relevant settings obtained from the first product settings;
a dependencies component for identifying and resolving dependencies between the first product and the second product;
a mapping component for mapping the configured first product settings and second product settings into roles for deployment to destination machines according to machine roles;
a deployment component for installing the first product and the second product as a product suite on the destination machines; and
a status component for providing installation progress information and logging information.

10. The system of claim 9, wherein the configuration component requests additional settings not included in the relevant settings for configuration of the second product.

11. The system of claim 9, further comprising a task component for queuing tasks to be executed on the destination machines, the tasks defining a role of a destination machine, and the deployment component facilitates selection of some or all of the tasks, the selection of which initiates remote installation of the product suite on one or more of the destination machines according to an assigned role.

12. A computer-implemented method of deploying an application, comprising:
receiving a workbench application for defining integration of products as a suite;
adding a first product to the workbench application;
configuring the first product via the workbench application using first product settings;
adding a second product to the workbench application;
resolving dependencies between the first product and the second product;
passing relevant settings of the first product settings to the second product for automatic setup of the second product based on the resolved dependencies;
automatically configuring the second product using the relevant settings; and
deploying the first product and the second product to destination machines in an orderly manner.

13. The method of claim 12, further comprising prompting for additional settings not provided in the relevant settings, the additional settings and relevant settings forming second product settings for configuring the second product.

14. The method of claim 13, further comprising mapping each of the first product settings and the second product settings to same or different roles.

15. The method of claim 14, further comprising assigning a role to a destination machine and deploying tasks to the destination machine for configuring the destination machine to the assigned role.

16. The method of claim 14, further comprising updating a role using the workbench application and updating destination machines currently operating in that role.

17. The method of claim 12, further comprising enqueuing tasks in the workbench application for deployment to a destination machine to automatically configure the destination machine.

18. The method of claim 17, further comprising selecting, some or all of the enqueued tasks to execute for remote installation on a destination machine.

19. The method of claim 12, further comprising receiving progress information back from the destination machine related to remote installation of a product.

20. The method of claim 12, further comprising receiving logging information back from the destination machine related to remote installation of a product.
